(19) United States
(12) Patent Application Publication
(10) Pub. No.: US 2017/0143131 A1
(43) Pub. Date: May 25, 2017

(54) HEAT EXCHANGE STRUCTURE FOR SUPPORT SURFACE

(71) Applicant: CAREMED SUPPLY INC., New Taipei City (TW)

(72) Inventor: Pao Ming SHIH, Taipei City (TW)

(73) Assignee: CAREMED SUPPLY INC., New Taipei City (TW)

(21) Appl. No.: 15/079,138

(22) Filed: Mar. 24, 2016

(30) Foreign Application Priority Data
Nov. 25, 2015 (TW) 104218964

(51) Int. Cl. A47C 21/04; A61G 7/057

(52) U.S. Cl. CPC A47C 21/044; A61G 7/05776; A61G 2007/05792; A61G 2203/70

(57) ABSTRACT

A heat exchange structure for support surface includes a mattress portion consisting of air cells disposed side-by-side, a mattress cover, a heat dissipation air cushion disposed between the mattress portion and the mattress cover, an air charging line, and an air supply unit connected to the heat dissipation air cushion via the air charging line. The heat dissipation air cushion has air holes formed on its top surface. When air is supplied from the air supply unit into the heat dissipation air cushion, an air chamber in the heat dissipation air cushion is expanded to create an air-flowing space between the mattress portion and the mattress cover. The air supplied into the air chamber continuously escapes from the heat dissipation air cushion into the air-flowing space to form air streams, which flow through and finally out of the air-flowing space while carrying heat and moisture away from the mattress cover.

### FIELD OF THE INVENTION

The present invention relates to a heat exchange structure for support surface, of which air cells are alternately inflated and deflated to prevent the development of pressure ulcers on a patient lying thereon; and more particularly, the present invention relates to a heat exchange structure for support surface, in which flowing air streams can be produced to carry heat away from the support surface when a patient is lying thereon, and accordingly, achieve the purpose of heat dissipation.

### BACKGROUND OF THE INVENTION

Bedridden patients and disabled persons often need other persons to help them to periodically move or roll their bodies on the bed, in order to change the distribution of pressure placed on their skin by the bed and maintain good blood flow to the skin tissues to minimize the development of bedsores or pressure ulcers due to lying on bed for a long time. It is laborious and costly to take care of bedridden patients and disabled persons. To solve this problem, there has been developed a support surface in the form of an alternating pressure air mattress, which internally includes many air cells controlled to contract and expand alternately, so as to redistribute the pressure imposed by the mattress on the bedridden patients' and disabled persons' bodies.

Usually, a vapor-impermeable material is used to make the air cells of the above-mentioned air mattress, so that the air cells can maintain their shapes when they are expanded. However, the vapor-impermeable air cells largely reduce the heat dissipation ability of the whole air mattress. While the alternate contraction and expansion of the air cells is helpful in minimizing the development of pressure ulcers, the vapor-impermeable air cells and the relatively poor heat dissipation ability of the air mattress cause discomfort to the patient or the disabled person lying on the air mattress. In some worse conditions, the poor heat dissipation of the air mattress will even lead to other skin problems, such as dermatitis. Even if an electric fan or an air conditioner can be used to assist in heat dissipation, air streams produced by the fan or the air conditioner are often stopped by the patient's clothes or the bed quilt from reaching the patient's body areas in contact with the air mattress.

Regarding the heat dissipation structure for patient support surfaces, U.S. Pat. No. 8,856,993 discloses a person-support surface that includes a mattress having an air flow path formed therein, so that air can be supplied into and then flow out of the air flow path to carry heat and moisture from the mattress.

The mattress for the person-support surface of U.S. Pat. No. 8,856,993 has a special structural design for use with a particularly designed support surface and can not be directly used with other conventional support surfaces or bed frames. Further, the specially designed person-support surface doubtlessly has largely increased manufacturing cost to lose its competition ability in the commercial markets.

### SUMMARY OF THE INVENTION

A primary object of the present invention is to provide a heat exchange structure for support surface that enhances the heat dissipation effect of a support surface and can be applied to and directly easily mounted on a variety of support surfaces without the need of changing the original structural designs of the support surfaces, so that bedridden patients and disabled persons lying on the support surfaces are protected from suffering other illnesses due to poor heat dissipation of the support surfaces.

Another object of the present invention is to provide a heat exchange structure for support surface, with which an air-flowing space can be formed between a mattress portion and a mattress cover, so that air in the air-flowing space is in contact with the whole mattress cover to thoroughly carry away heat and moisture from the mattress cover, giving the support surface a largely upgraded ability to remove heat and moisture therefrom.

To achieve the above and other objects, the heat exchange structure for support surface according to a preferred embodiment of the present invention includes a mattress portion consisting of a plurality of air cells, which are disposed side-by-side to provide a mattress top surface; a mattress cover disposed on the mattress top surface formed of the air cells to cover the mattress portion; a heat dissipation air cushion disposed between the mattress portion and the mattress cover, the heat dissipation air cushion including an internal air chamber, which is expandable in volume when air is supplied thereinto, and a plurality of air holes and at least one communicating port formed on a top surface of the heat dissipation air cushion; an air charging line connected at an end to the at least one communicating port on the heat dissipation air cushion; and an air supply unit connected to another end of the air charging line and capable of continuously supplying air to the air charging line.

The air chamber is expanded in volume when air is supplied from the air supply unit into the heat dissipation air cushion via the air charging line. The expanded air chamber spaces the mattress portion and the mattress cover apart, so that an air-flowing space is created between them. The air supplied into the air chamber continuously escapes from the heat dissipation air cushion into the air-flowing space via the air holes on the top surface of the heat dissipation air cushion, forming heat-dissipating air streams that flow through and finally out of the air-flowing space while carrying heat and moisture away from the mattress cover.

The heat dissipation air cushion is formed of at least one connection section, on which the at least one communicating port is provided, and a pressing section communicable with the at least one connection section.

The pressing section is a ring-shaped structure having a central hollow portion, so that the pressing section in an inflated and expanded state has only a limited overall height without causing any discomfort to the patient lying on the support surface.

A supporting layer is further provided to extend between the heat dissipation air cushion and the mattress portion, lest the heat dissipation air cushion should become trapped in a gap formed between two adjacent air cells to cause inconvenience in using the support surface.

The air cells of the mattress portion are respectively connected to the air supply unit via an air input line. The air input lines are grouped into first input lines, which are respectively connected to one air cell located at an odd-number position, and second input lines, which are respectively connected to one air cell located at an even-number position. The air cells connected to the first input lines and to the second input lines are controlled to alternately present an inflated or a deflated state and accordingly, produce changes in their heights, so that the mattress portion can redistribute the pressure placed on the patient lying on the mattress cover

Further, a stopper is disposed on each of two opposite sides of the mattress top surface for preventing the patient from accidentally falling off the support surface. The stoppers are respectively a volume changeable fall-stopping cushion connected to the air supply unit via a connecting line, so that a filling gas such as air can be supplied into the stoppers.

The present invention is characterized in that air is supplied from the air supply unit into the heat dissipation air cushion disposed between the mattress portion and the mattress cover, so that the expanded heat dissipation air cushion spaces the mattress portion and the mattress cover apart to create an air-flowing space between them, and that the air supplied into the air chamber continuously escapes from the heat dissipation air cushion into the air-flowing space via the air holes on the top surface of the heat dissipation air cushion, forming heat-dissipating air streams that are helpful in quickly carrying heat and moisture away from the support surface.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a heat exchange structure for support surface according to a first embodiment of the present invention;

FIG. 2 is an enlarged view of the circled area A of FIG. 1;

FIG. 3 is an enlarged view of the circled area B of FIG. 1;

FIG. 4 is an enlarged view of the circled area C of FIG. 1;

FIG. 5 is an assembled view of FIG. 1;

FIG. 6 is a top view of FIG. 5;

FIG. 7 is a sectional view taken along line 1-1 of FIG. 6;

FIG. 8 is an enlarged view of the circled area D of FIG. 7;

FIG. 9 is a sectional view taken along line 2-2 of FIG. 6;

FIG. 10 is an exploded perspective view of the heat exchange structure for support surface according to a second embodiment of the present invention; and

FIG. 11 is an enlarged view of a heat dissipation air cushion adopted in the second embodiment of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

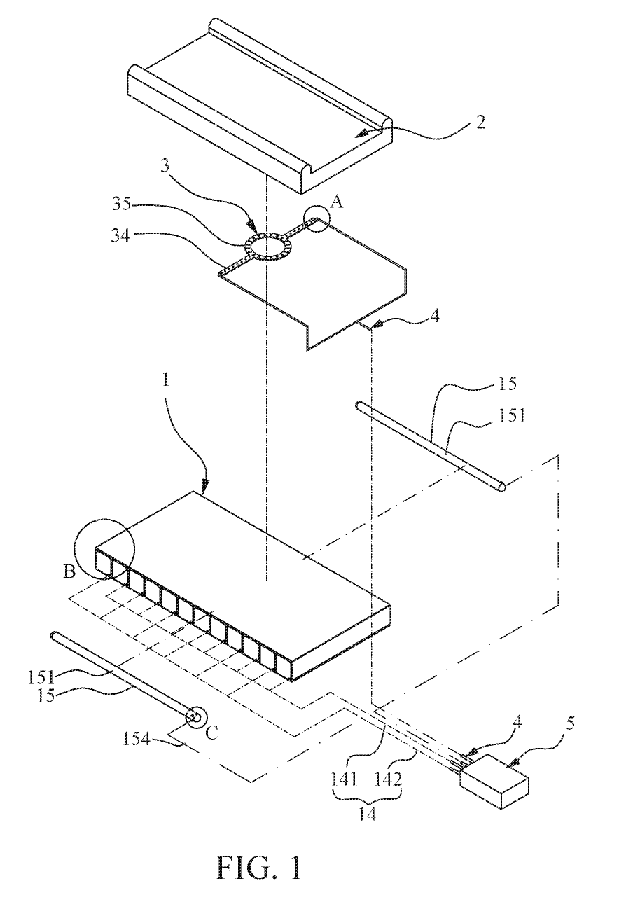

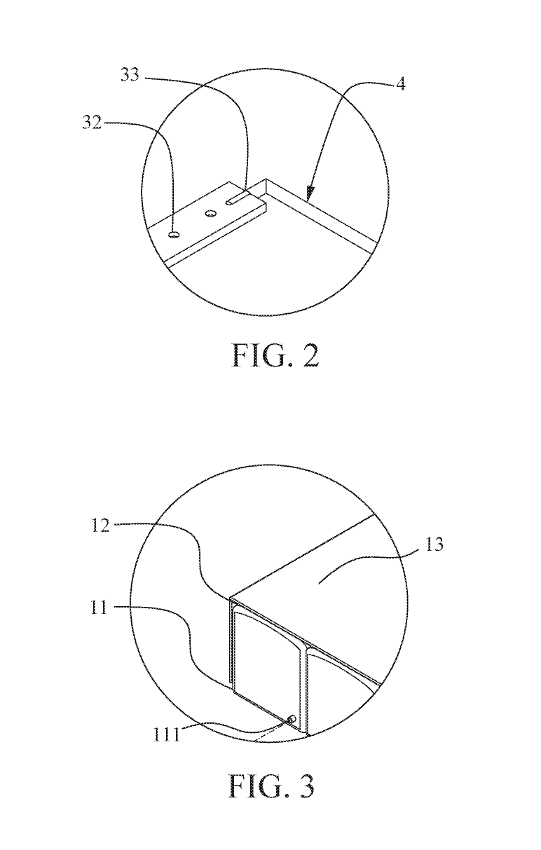

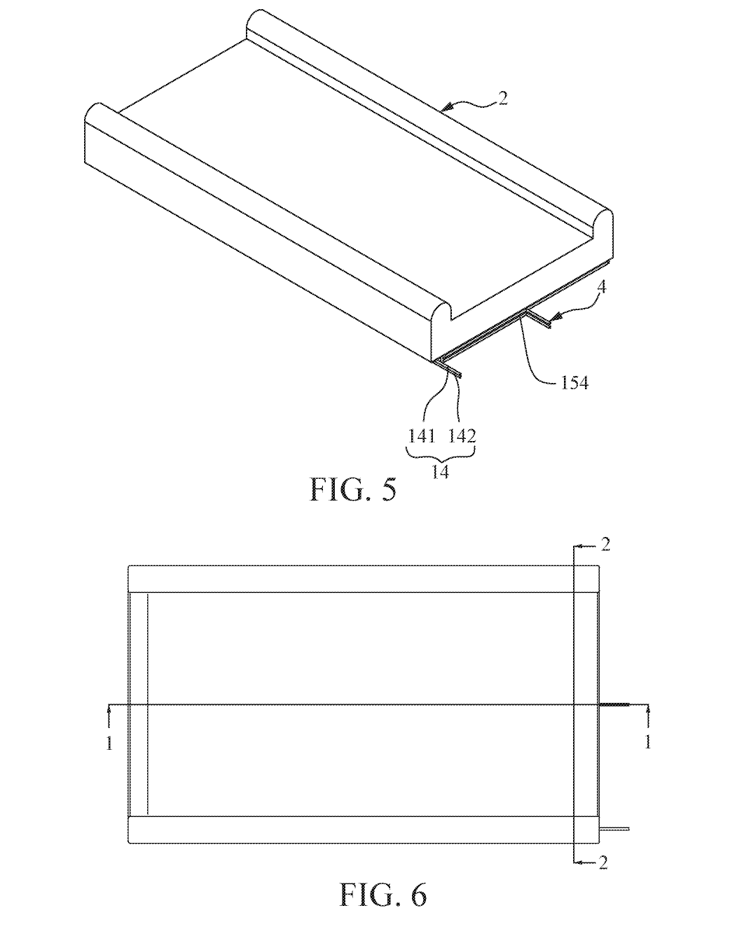

Please refer to FIGS. 1 through 5, in which a heat exchange structure for support surface according to a first embodiment of the present invention is shown. For the purpose of conciseness, the present invention is also briefly referred to as the heat exchange structure herein. As can be seen in FIG. 1, the heat exchange structure includes a mattress portion 1, a mattress cover 2, a heat dissipation air cushion 3, an air charging line 4, and an air supply unit 5. The mattress portion 1 internally includes a plurality of air cells 11, which are disposed side-by-side to provide a mattress top surface 12. The mattress cover 2 is disposed on the mattress top surface 12 to cover the mattress portion 1. The heat dissipation air cushion 3 is disposed between the mattress top surface 12 and the mattress cover 2 at a position corresponding to the buttocks of a patient lying on the mattress cover 2. Further, a supporting layer 13 is provided and extended between the mattress top surface 12 and the heat dissipation air cushion 3 and is fixedly bonded to two longitudinal ends of the mattress portion 1.

Referring to FIG. 3. The air cells 11 respectively have an air inlet connector 111 for connecting to an air input line 14. The air input lines 14 are grouped according to the positions of the air cells 11 they are connected to. More specifically, the air input lines 14 are grouped into first input lines 141, which are respectively connected to an air cell 11 located at an odd-number position, and second input lines 142, which are respectively connected to an air cell 11 located at an even-number position. All the first and second input lines 141, 142 are connected to the air supply unit 5. The air cells 11 connected to the first input lines 141 and to the second input lines 142 are controlled via the air supply unit 5 to alternately present an inflated or a deflated state, so that the mattress portion 1 can redistribute the pressure placed on the patient lying on the mattress cover 2 to reduce the chance of developing bedsores or pressure ulcers. The supporting layer 13 can prevent the heat dissipation air cushion 3 from falling into a gap formed between two adjacent air cells 11 when the mattress portion 1 redistributes the pressure placed on the patient.

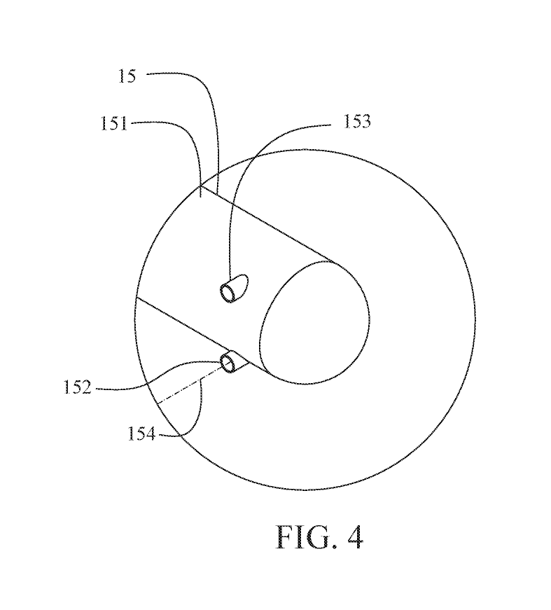

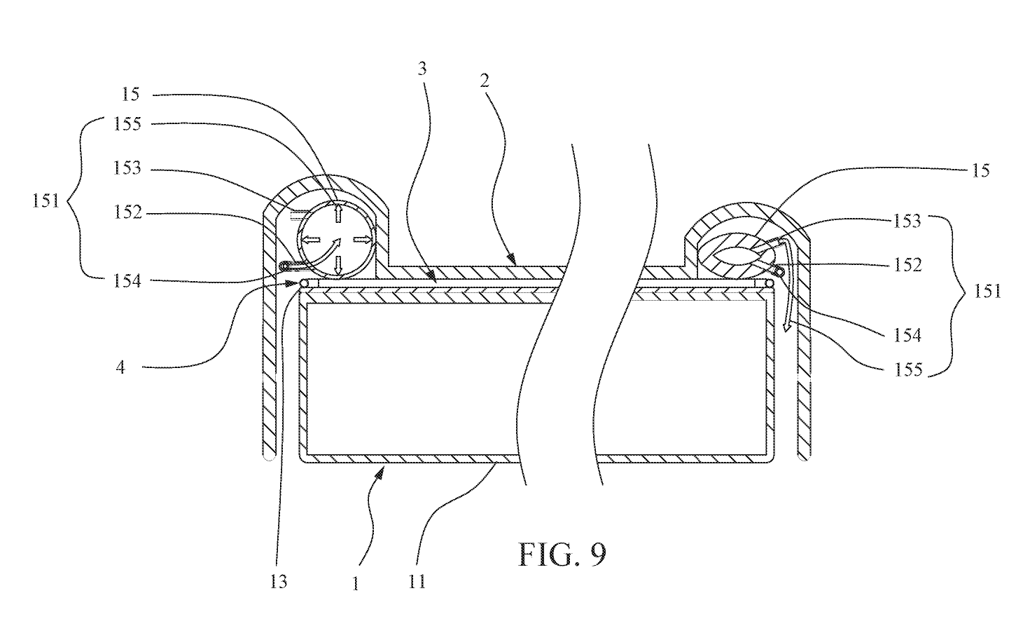

A stopper 15 is further disposed on each of two longitudinal sides of the mattress top surface 12 formed by the air cells 11. Please refer to FIGS. 4 and 9. The stopper 15 is an inflatable and deflatable fall-stopping cushion 151, on which an inflating port 152 and a closeable air venting port 153 are provided. The inflation port 152 is connected to an end of a connecting line 154, and another end of the connecting line 154 is connected to the air supply unit 5.

Referring to FIG. 9. When the air venting port 153 of the fall-stopping cushion 151 is opened to let out a filling gas 155 (i.e., air in this embodiment) from the fall-stopping cushion 151, the volume of the fall-stopping cushion 151 is reduced, enabling the patient to move down from or onto the support surface more easily. When the patient has safely lain down on the support surface, the air venting port 153 is closed and the air supply unit 5 is controlled to supply the filling gas 155 into the fall-stopping cushion 151 to inflate the same. With the fall-stopping cushion 151 in an inflated state, the possibility that the patient might fall down from the support surface is reduced.

Referring to FIGS. 1, 2, 7 and 8. The heat dissipation air cushion 3 includes an air chamber 31, a plurality of air holes 32 and two communicating ports 33. The air chamber 31 is enclosed in the heat dissipation air cushion 3; the air holes 32 are formed on a top surface of the heat dissipation air cushion 3; and the two communicating ports 33 are connected to the air charging line 4, which is in turn connected to the air supply unit 5. The air chamber 31 is expanded when air is supplied from the air supply unit 5 into the heat dissipation air cushion 3 via the two communicating ports 33.

As shown in FIG. 1, the heat dissipation air cushion 3 is generally formed of two connection sections 34 and a pressing section 35. The two connection sections 34 are located at two diametrically opposite sides of the pressing section 35, and the two communicating ports 33 are separately provided on the two connection sections 34. Since air is simultaneously supplied from the air supply unit 5 into the heat dissipation air cushion 3 via two different positions, i.e. the two communicating ports 33 on the two connection sections 34, the air chamber 31 can have more evenly distributed internal pressure. The pressing section 35 is a ring-shaped structure having a central hollow portion. With this configuration, the pressing section 35 in an inflated state will have only a limited height after expansion and accordingly, will not cause any discomfort to the patient lying on the support surface when the air supply unit 5 supplies air into the heat dissipation air cushion 3.

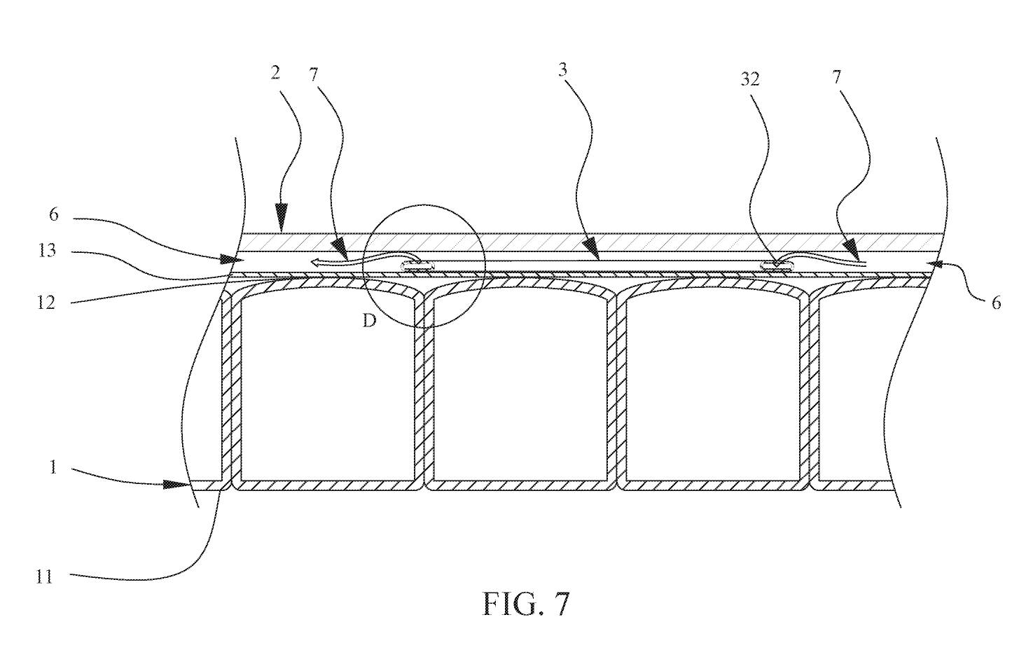

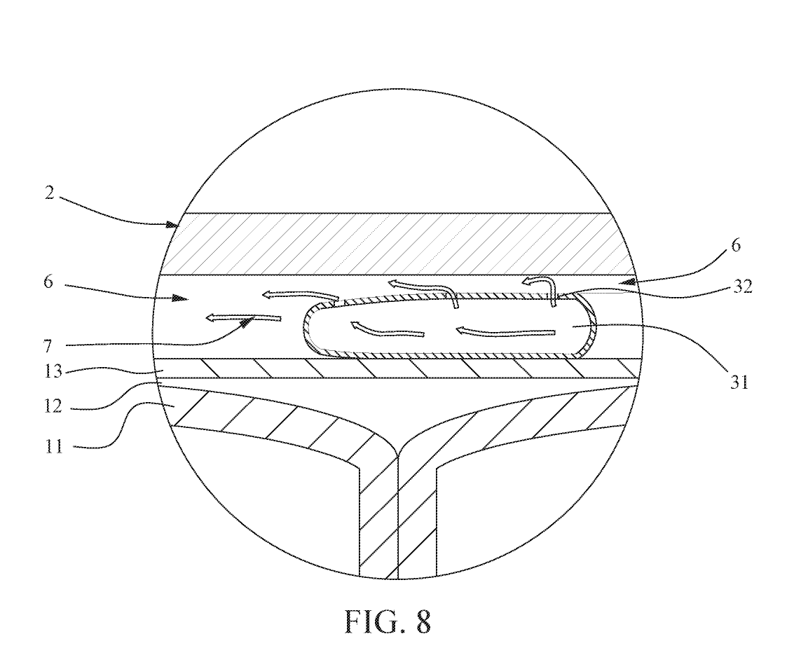

Referring to FIGS. 7 and 8. When air is supplied from the air supply unit 5 into the heat dissipation air cushion 3, the air chamber 31 of the heat dissipation air cushion 3 is expanded in volume to upwardly push against and accordingly raise the mattress cover 2. At this point, an air-flowing space 6 is created between the mattress cover 2 and the mattress portion 1. Meanwhile, the air supplied into the air chamber 31 continuously escapes from the heat dissipation air cushion 3 into the air-flowing space 6 via the air holes 32 on the top surface of the heat dissipation air cushion 3, forming heat-dissipating air streams 7 that flow through and finally out of the air-flowing space 6 while carrying heat and moisture away from the mattress cover 2 to achieve the purpose of heat dissipation.

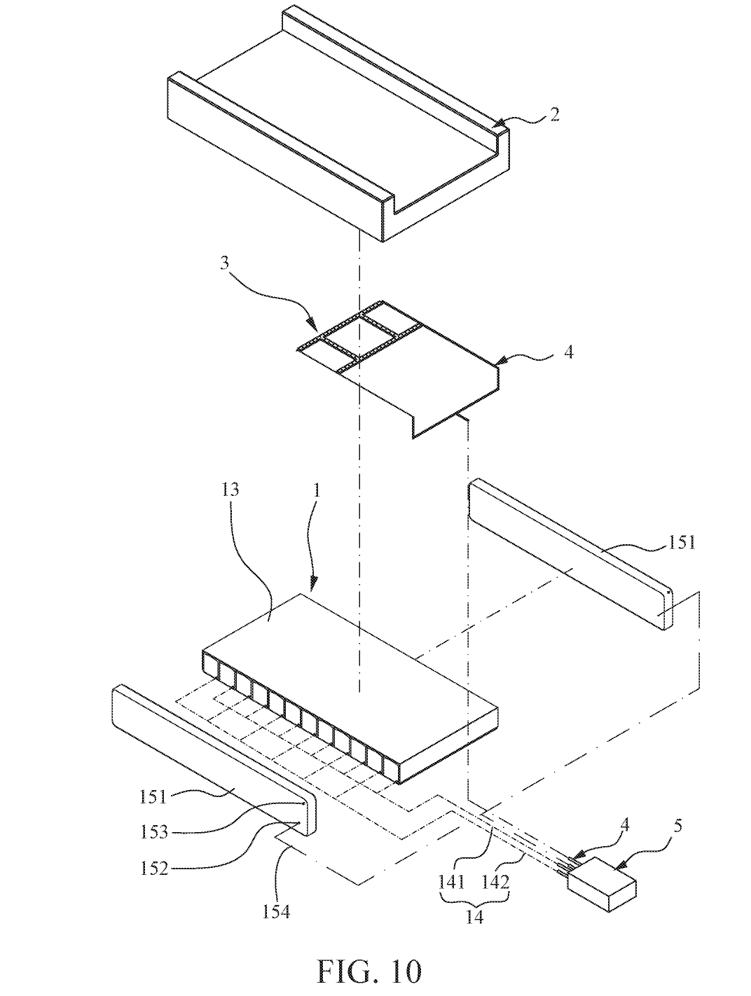

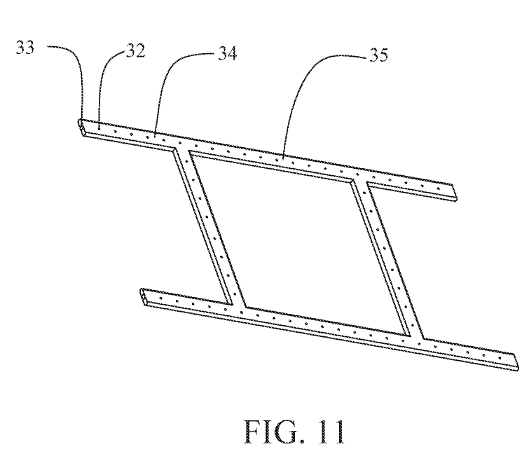

FIG. 10 is an exploded perspective view of the heat exchange structure for support surface according to a second embodiment of the present invention. The second embodiment is generally structurally similar to the first embodiment but has differently designed fall-stopping cushions 151 and heat dissipation air cushion 3. In the second embodiment, the fall-stopping cushions 151 are respectively in the shape of a rectangular cuboid and are disposed at two longitudinal sides of the mattress portion 1. FIG. 11 is a perspective view of the heat dissipation air cushion 3 included in the second embodiment of the present invention. As shown, in the second embodiment, the heat dissipation air cushion 3 has a pressing section 35 in the shape of a quadrilateral with four connection sections 34 separately located at four corners of the pressing section 35. Each of the connection sections 34 has a communicating port 33 provided thereat for connecting to the air charging line 4. With the increased number of connection sections 34 provided on the heat dissipation air cushion 3, it is able to avoid the risk of lowered heat-dissipating air stream forming function caused by compressed and deformed connection sections 34 under the patient's weight and accordingly, failed supply of air from the air supply unit 5 to the heat dissipation air cushion 3. In the event any or some of the four connection sections 34 in use are compressed, deformed and clogged, the rest ones can still function to ensure the supply of air into the air chamber 31 and keep the heat dissipation air cushion 3 workable.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A heat exchange structure for support surface, comprising:
a mattress portion consisting of a plurality of air cells, which are disposed side-by-side to provide a mattress top surface;
a mattress cover being disposed on the mattress top surface to cover the mattress portion;
a heat dissipation air cushion being disposed between the mattress portion and the mattress cover; the heat dissipation air cushion including an internal air chamber, which is expandable when air is supplied thereinto, and a plurality of air holes and at least one communicating port formed on a top surface of the heat dissipation air cushion;
an air charging line being connected at an end to the at least one communicating port on the heat dissipation air cushion; and
an air supply unit being connected to another end of the air charging line;
wherein the air chamber of the heat dissipation air cushion is expanded in volume when air is supplied from the air supply unit into the heat dissipation air cushion via the air charging line, and the expanded air chamber spaces the mattress portion and the mattress cover apart to create an air-flowing space between them; and wherein the air supplied into the air chamber continuously escapes from the heat dissipation air cushion into the air-flowing space via the air holes on the top surface of the heat dissipation air cushion, forming heat-dissipating air streams that flow through and finally out of the air-flowing space while carrying heat and moisture away from the mattress cover.

2. The heat exchange structure for support surface as claimed in claim 1, wherein the air cells of the mattress portion are respectively connected to the air supply unit via an air input line; and the air input lines being grouped into first input lines, which are respectively connected to one air cell located at an odd-number position, and second input lines, which are respectively connected to one air cell located at an even-number position.

3. The heat exchange structure for support surface as claimed in claim 1, wherein the heat dissipation air cushion is formed of at least one connection section, on which the at least one communicating port is provided, and a pressing section communicable with the at least one connection section.

4. The heat exchange structure for support surface as claimed in claim 3, wherein the pressing section is a ring-shaped structure having a central hollow portion, so as to reduce an overall height of the pressing section when it is inflated and expanded.

5. The heat exchange structure for support surface as claimed in claim 1, further comprising a supporting layer provided and extended between the heat dissipation air cushion and the mattress portion to prevent the heat dissipation air cushion from trapping in a gap formed between two adjacent air cells.

6. The heat exchange structure for support surface as claimed in claim 1, further comprising a stopper disposed on each of two opposite longitudinal sides of the mattress top surface.

7. The heat exchange structure for support surface as claimed in claim 6, wherein the stoppers are respectively a volume changeable fall-stopping cushion, and are respectively connected to the air supply unit via a connecting line.
